(19) United States
(12) Patent Application Publication
(10) Pub. No.: US 2016/0299546 A1
(43) Pub. Date: Oct. 13, 2016

(54) CENTRAL PROCESSING UNIT PROTECTION CIRCUIT

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: WEI-YING GONG, Wuhan (CN); CHUN-SHENG CHEN, New Taipei (TW)

(21) Appl. No.: 14/697,194

(22) Filed: Apr. 27, 2015

(30) Foreign Application Priority Data
Apr. 10, 2015 (CN) 201510166422.0

(51) Int. Cl. G06F 1/26

(52) U.S. Cl. CPC G06F 1/26

(57) ABSTRACT

A central processing unit (CPU) protection circuit for providing power supply for a CPU on a motherboard includes a detection unit, a south bridge chip and a switch circuit. The detection unit includes a first detection terminal and a second detection terminal. The south bridge chip is electrically coupled to the first detection terminal and is configured to detect a detection signal and receive a direct current (DC) voltage via a first resistor. The switch circuit is configured to receive the detection signal, and output a first control signal to the south bridge chip according to the detection signal.

### CROSS-REFERENCE TO RELATED APPLICATIONS

This application claims priority to Chinese Patent Application No. 201510166422.0 filed on Apr. 10, 2015, the contents of which are incorporated by reference herein in its entirety.

### FIELD

The subject matter herein generally relates to a central processing unit (CPU) protection circuit.

### BACKGROUND

In electronics and particularly in computer electronics, sockets are typically used to fix central processing units (CPUs) on printed circuit boards, such as the motherboards of computers. A typical CPU power circuit does not have a protection function, allowing that the CPU could be damaged when a short circuit occurs.

### BRIEF DESCRIPTION OF THE DRAWINGS

Implementations of the present technology will now be described, by way of example only, with reference to the attached figures.

FIG. 1 is a block diagram of an embodiment of a central processing unit protection circuit.

FIG. 2 is a circuit diagram of the central processing unit protection circuit of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like. “Unit” means a collection of electronic hardware alone or in combination with software configured for a particular task or function, although units may overlap or share components.

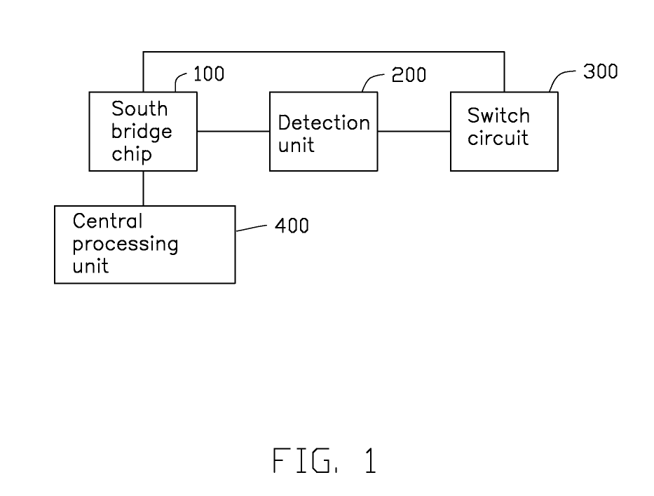

FIG. 1 illustrates a central processing unit (CPU) protection circuit in accordance with one embodiment. The CPU protection circuit includes a south bridge chip 100, a detection unit 200, and a switch circuit 300. The CPU protection circuit is configured to provide power supply for a CPU 400 on a motherboard (not shown).

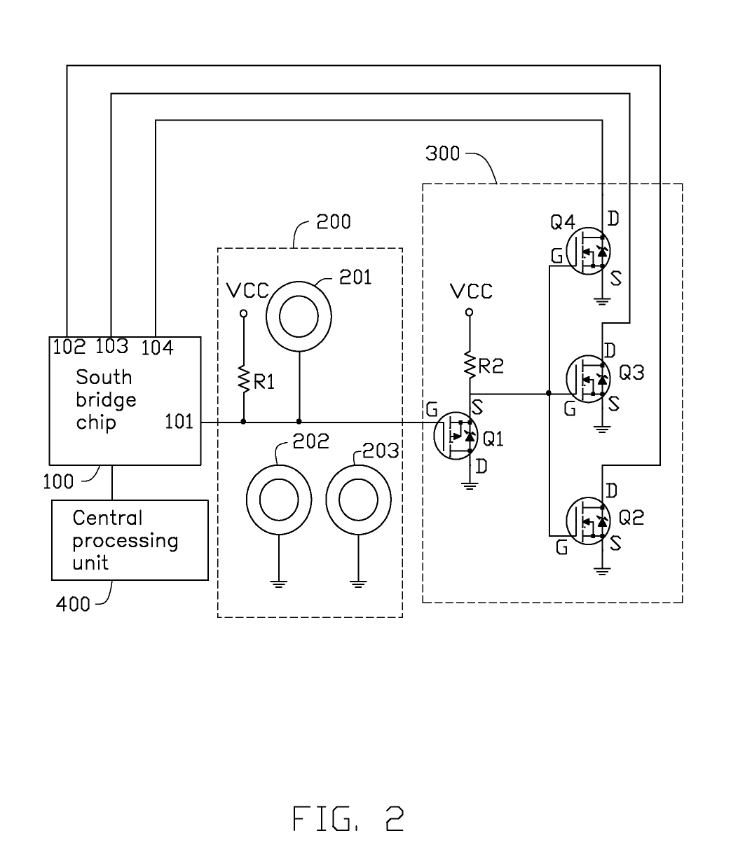

FIG. 2 illustrates that the south bridge chip 100 includes a first general purpose input/output (GPIO) port 101, a second GPIO port 102, a third GPIO port 103, and a fourth GPIO port 104. The detection unit 200 includes a first detection terminal 201, a second detection terminal 202, a third detection terminal 203, and a first resistor R1. The first GPIO port 101 is electrically coupled to the first detection terminal 201. The first GPIO port 101 is configured to receive a direct current (DC) voltage VCC via the first resistor R1. The second detection terminal 202 and the third detection terminal 203 are grounded.

In at least one embodiment, the DC voltage Vcc is +3 volts.

The switch circuit 300 includes a first switch Q1, a second switch Q2, a third switch Q3, a fourth switch Q4, and a second resistor R2. Each of the first switch Q1, the second switch Q2, the third switch Q3, and the fourth switch Q4 includes a first terminal, a second terminal, and a third terminal.

The first terminal of the first switch Q1 is electrically coupled to the first detection terminal 201. The second terminal of the first switch Q1 is configured to receive the DC voltage Vcc via the second resistor R2. The third terminal of the first switch Q1 is grounded. The first terminals of the second switch Q2, the third switch Q3, and the fourth switch Q4 are electrically coupled to the second terminal of the first switch Q1. The second terminals of the second switch Q2, the third switch Q3, and the fourth switch Q4 are grounded. The third terminals of the second switch Q2, the third switch Q3, and the fourth switch Q4 are configured to output a first control signal, a second control signal, and a third control signal to the second GPIO port 102, the third GPIO port 103, and the fourth GPIO port 104 of the south bridge chip 100 respectively.

In at least one embodiment, the first switch Q1 is an p channel metal-oxide-semiconductor field-effect transistor (MOSFET), the second switch Q2, the third switch Q3, and the fourth switch Q4 are n channel MOSFETs, and the first terminal, the second terminal, and the third terminal of each of the first switch Q1, the second switch Q2, the third switch Q3, and the fourth switch Q4 are gate, source, and drain respectively.

When the CPU 400 is normally fixed to the motherboard, the first detection terminal 201 is electrically coupled to the second detection terminal 202 and the third detection terminal 203. The first detection terminal 201 is grounded via the second detection terminal 202 and the third detection terminal 203. The first GPIO port 101 of the south bridge chip 100 detects a detection signal of low voltage level. The first terminal of the first switch Q1 is configured to receive the detection signal of low voltage level. The first switch Q1 turns on. The second terminal of the first switch Q1 is configured to output a switch signal of low voltage level. The second switch Q2, the third switch Q3, and the fourth switch Q4 all turn off. The third terminals of the second switch Q2, the third switch Q3, and the fourth switch Q4 are configured to output the first control signal, the second control signal, and the third control signal of normal voltage level to the second GPIO port 102, the third GPIO port 103, and the fourth GPIO port 104 of the south bridge chip 100 respectively. The south bridge chip 100 is configured to provide power supply for the CPU 400, the memory unit (not shown), and other electronic components (not shown) on the motherboard.

When the CPU 400 is abnormally fixed to the motherboard, the first detection terminal 201 is not electrically coupled to the second detection terminal 202 and the third detection terminal 203. The first GPIO port 101 of the south bridge chip 100 detects a detection signal of high voltage level. The first terminal of the first switch Q1 is configured to receive the detection signal of high voltage level. The first switch Q1 turns off. The second terminal of the first switch Q1 is configured to output a switch signal of high voltage level. The second switch Q2, the third switch Q3, and the fourth switch Q4 all turn on. The third terminals of the second switch Q2, the third switch Q3, and the fourth switch Q4 are configured to output the first control signal, the second control signal, and the third control signal of low voltage level to the second GPIO port 102, the third GPIO port 103, and the fourth GPIO port 104 of the south bridge chip 100 respectively. The south bridge chip 100 is configured to cut off the power supply for the CPU 400, the memory unit (not shown), and other electronic components (not shown) on the motherboard. Therefore, the CPU 400 is protected from being damaged when a short circuit occurs.

The embodiments shown and described above are only examples. Many details are often found in the art such as the other features of a central processing unit protection circuit. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A central processing unit (CPU) protection circuit for providing power supply for a CPU on a motherboard, the circuit comprising:
a detection unit comprising a first detection terminal and a second detection terminal;
a south bridge chip electrically coupled to the first detection terminal and configured to detect a detection signal and receive a direct current (DC) voltage via a first resistor; and
a switch circuit configured to receive the detection signal, and output a first control signal to the south bridge chip according to the detection signal,
wherein the south bridge chip is configured to detect the detection signal of a first voltage level, the switch circuit is configured to receive the detection signal of the first voltage level and output the first control signal of a first voltage level, and the south bridge chip is further configured to receive the first control signal of the first voltage level and cut off the power supply for the CPU, in event the CPU is abnormally fixed to the motherboard or the first detection terminal is not electrically coupled to the second detection terminal.

2. The CPU protection circuit of claim 1, wherein the detection unit further comprises a third detection terminal; the south bridge chip comprises a first general purpose input/output (GPIO) port; the third detection terminal is grounded; the first GPIO port is electrically coupled to the first detection terminal; and the first GPIO port is configured to receive the DC voltage via the first resistor.

3. The CPU protection circuit of claim 2, wherein when the CPU is normally fixed to the motherboard, the first detection terminal is electrically coupled to the second detection terminal and the third detection terminal; and when the CPU is abnormally fixed to the motherboard, the first detection terminal is not electrically coupled to the second detection terminal and the third detection terminal.

4. The CPU protection circuit of claim 2, wherein the DC voltage is +3 volts.

5. The CPU protection circuit of claim 2, wherein the south bridge chip further comprises a second GPIO port; the switch circuit comprises a first switch, a second switch, and a second resistor; each of the first switch and the second switch comprises a first terminal, a second terminal, and a third terminal; the first terminal of the first switch is electrically coupled to the first detection terminal; the second terminal of the first switch is configured to receive the DC voltage via the second resistor; the third terminal of the first switch is grounded; the first terminal of the second switch is electrically coupled to the second terminal of the first switch; the second terminal of the second switch is grounded; and the third terminal of the second switch configured to output the first control signal to the second GPIO port of the south bridge chip.

6. The CPU protection circuit of claim 5, wherein the first switch is an p channel metal-oxide-semiconductor field-effect transistor (MOSFET), the second switch is an n channel MOSFET, and the first terminal, the second terminal, and the third terminal of each of the first switch and the second switch are gate, source, and drain respectively.

7. A central processing unit (CPU) protection circuit for providing power supply for a CPU on a motherboard, the circuit comprising:
a detection unit comprising a first detection terminal and a second detection terminal;
a south bridge chip electrically coupled to the first detection terminal and configured to detect a detection signal and receive a direct current (DC) voltage via a first resistor; and
a switch circuit configured to receive the detection signal, and output a first control signal to the south bridge chip according to the detection signal,
wherein the south bridge chip is configured to detect the detection signal of a first voltage level, the switch circuit is configured to receive the detection signal of the first voltage level and output the first control signal of a first voltage level, and the south bridge chip is further configured to receive the first control signal of the first voltage level and provide power supply for the CPU, in event the CPU is normally fixed to the motherboard or the first detection terminal is electrically coupled to the second detection terminal, and
wherein the south bridge chip is configured to detect the detection signal of a second voltage level, the switch circuit is configured to receive the detection signal of the second voltage level and output the first control signal of a second voltage level, and the south bridge chip is further configured to receive the first control signal of the second voltage level and cut off the power supply for the CPU, in event the CPU is abnormally fixed to the motherboard or the first detection terminal is not electrically coupled to the second detection terminal.

8. The CPU protection circuit of claim 7, wherein the detection unit further comprises a third detection terminal; the south bridge chip comprises a first general purpose input/output (GPIO) port; the third detection terminal is grounded; the first GPIO port is electrically coupled to the first detection terminal; and the first GPIO port is configured to receive the DC voltage via the first resistor.

9. The CPU protection circuit of claim 8, wherein when the CPU is normally fixed to the motherboard, the first detection terminal is electrically coupled to the second detection terminal and the third detection terminal; and when the CPU is abnormally fixed to the motherboard, the first detection terminal is not electrically coupled to the second detection terminal and the third detection terminal.

10. The CPU protection circuit of claim 8, wherein the DC voltage is +3 volts.

11. The CPU protection circuit of claim 8, wherein the south bridge chip further comprises a second GPIO port; the switch circuit comprises a first switch, a second switch, and a second resistor; each of the first switch and the second switch comprises a first terminal, a second terminal, and a third terminal; the first terminal of the first switch is electrically coupled to the first detection terminal; the second terminal of the first switch is configured to receive the DC voltage via the second resistor; the third terminal of the first switch is grounded; the first terminal of the second switch is electrically coupled to the second terminal of the first switch; the second terminal of the second switch is grounded; and the third terminal of the second switch configured to output the first control signal to the second GPIO port of the south bridge chip.

12. The CPU protection circuit of claim 11, wherein the first switch is an p channel metal-oxide-semiconductor field-effect transistor (MOSFET), the second switch is an n channel MOSFET, and the first terminal, the second terminal, and the third terminal of each of the first switch and the second switch are gate, source, and drain respectively.
